(19) United States
(12) Patent Application Publication
(10) Pub. No.: US 2006/0271860 A1
(43) Pub. Date: Nov. 30, 2006

(54) Custom wallpaper border

(76) Inventor: Dave Walter, Johnston, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/139,132

(22) Filed: May 27, 2005

(51) Int. Cl. G06F 9/00

(52) U.S. Cl. 715/738

(57) ABSTRACT

A method for creating a personal wallpaper border, comprising providing a computer software application for performing the steps of the method. Wherein the steps comprise the steps of launching the software application; selecting at least one standard image; selecting at least one personalized image; arranging the images in a predetermined pattern to create a wallpaper border segment; and creating a computer readable output file comprised of the arranged images adapted to be printed as a wallpaper border.

### BACKGROUND OF THE INVENTION

1. Field of the Invention

The present invention relates to a method for creating a customized wallpaper border. In particular, the method provides for a computer software application that performs the steps of selecting and arranging a combination of standard and personalized images into a wallpaper border.

2. Background

Wallpaper borders are well known in the art. A small decorative strip is placed around the upper perimeter of a room or wall of a room. The border typically is thematically or decoratively related to the remainder of the wall covering. The wallpaper border is conventionally and permanently applied to create an aesthetically pleasing appearance.

The border typically is comprised of a strip about four to six inches in height, and feature a repeating pattern that can vary in length from a few inches to twenty-four inches or more. The borders are cut to length depending on wall size, and then applied thereto.

While a wide arrange of designs are available for wallpaper borders, the choices are still limited to pre-designed images and patterns. Accordingly, a need exists for an improved method of creating a wallpaper border.

### SUMMARY OF THE INVENTION

An object of the present invention is providing an improved method for creating a personalized wallpaper border.

These and other objects of the present invention will become apparent to those skilled in the art upon reference to the following specification, drawings, and claims.

The present invention intends to overcome the difficulties encountered heretofore. To that end, a method for creating a personalized wallpaper border is provided, comprising providing a computer software application for performing the steps of the method. Wherein the steps comprise the steps of launching the software application; selecting at least one standard image; selecting at least one personalized image; arranging the images in a predetermined pattern to create a wallpaper border segment; and creating a computer readable output file comprised of the arranged images adapted to be printed as a wallpaper border.

### BRIEF DESCRIPTION OF THE DRAWINGS

FIG. 1 is a schematic flowchart of the method of the present invention.

FIGS. 2 through 10 are pseudo application software screen shots showing a software application implementation of the present invention.

FIGS. 11-12 are pseudo application software screen shots of an alternative software implementation of the present invention.

### DETAILED DESCRIPTION OF THE INVENTION

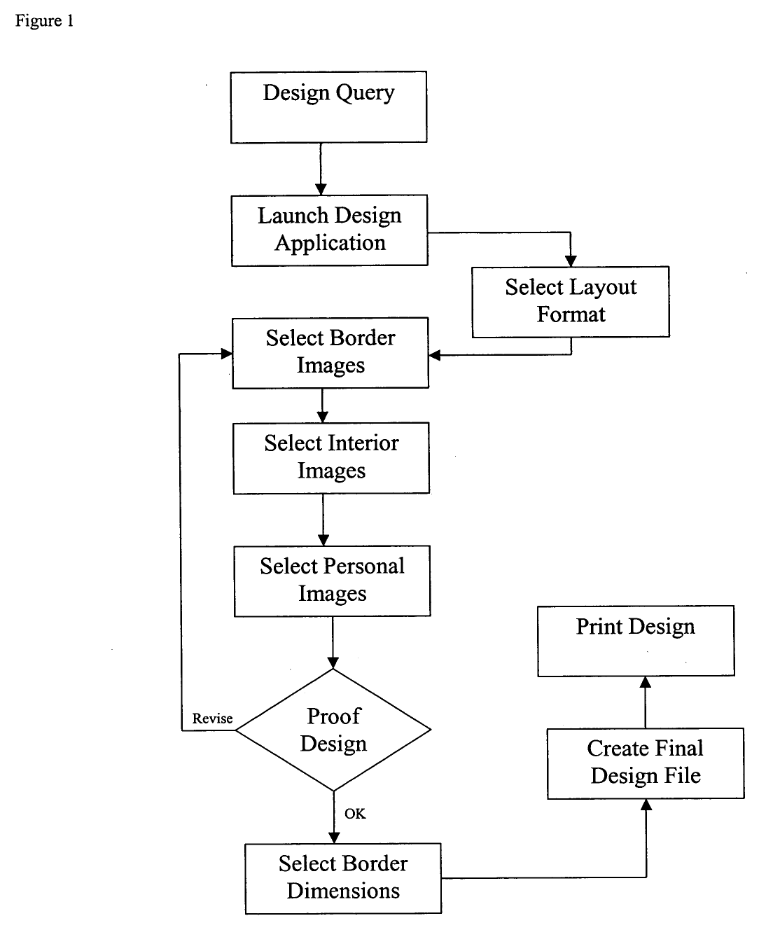

In the Figures, a method of creating a custom wallpaper border is shown. In particular, FIG. 1 shows a schematic flowchart of the method. The preferred embodiment of the invention is implemented through a computer controlled software application. Most preferably, the application would be implemented for use over a global computer information network such as the Internet. A plurality of users could access the application over the Internet, or any other type of computer information network. Alternatively, the user could access the program on a stand-alone computer located at a retail facility or some other convenient location.

The first step in the process comprises a design query. In this step the user would be asked a plurality of questions to assist in identifying the user and in determining an overall theme for the wallpaper border. For example, the query would elicit information about the general subject matter of the images to be used on the border, i.e. baseball, basketball, football, quilting, trains, nature, animals, pets, school, cartoon characters, cooking, fishing, arts & crafts. This would affect default settings for some of the directory options drop down menus appearing in the software application. If a sports theme is selected, further query would determine the type of sport, the level of sport, and then system would default to a directory containing images specific to the selection criteria. For example, if the user selects a professional baseball theme, and then further selects the Chicago Cubs, then the system defaults to an image directory containing images of Cubs players, logos, uniforms, and Wrigley Field. The query may determine other information as well, like names, addresses, and the like.

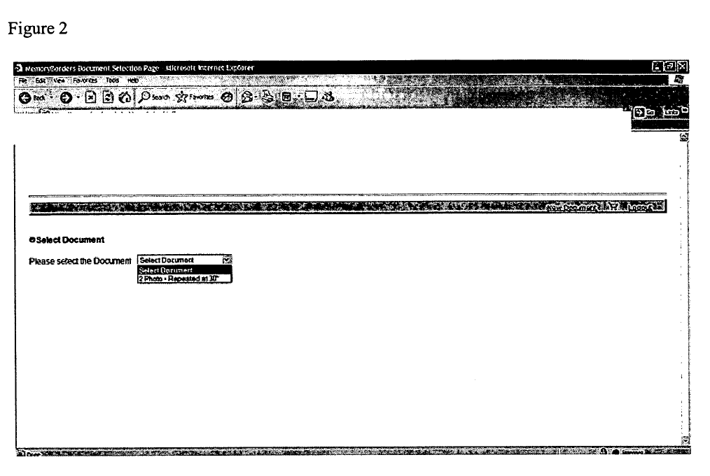

After the design query step the design application is launched. The design application again is a web or Internet based software application in the preferred embodiment. The application takes the user through the steps of designing and creating a custom wallpaper border. The final product is a high quality printer ready digital image file. The file can be transferred electronically, or by other means, to a wallpaper printer site for preparation of the actual wallpaper border. The particular details of the design application are described in general reference to FIG. 1, and in greater detail by reference to application program screens in FIGS. 2-10.

The general process involves selecting a number of standardized images that are previously created and stored in a central memory location. The standard images are then combined with a number of custom or personalized images provided by the user. The standard images are related to the theme chosen during the design query step, and the custom or personalized images may also be related thereto. To illustrate, a user who would like to design a wallpaper border for a child's bedroom could choose a theme of interest to the child, like sports. If the child is interested in professional football, and specifically the St. Louis Rams, and plays on a little league football team, the method of the present invention would easily allow for creating a wallpaper border to combine the child's general interest with specific images related thereto. The application would allow for selection of a variety of standardized images relating to the Rams, like team jersey, logos, players pictures, and the like, and would allow for combining those images with personal photographs of the child in his/her little league uniform or at games to create a unique wallpaper border for the child's room. Of course, those of ordinary skill in the art will understand that the themes and the type of standardized images are nearly limitless, and the invention in not limited to any particular subset thereof.

The general steps in the process include selecting a layout format. The wallpaper border consists of a plurality of repeating segments, wherein each segment is created from the selected images. The layout selected will determine the length of each wallpaper border segment and the number of personal or customized images per segment.

Next, the process proceeds to the select border images steps. The typical arrangement of images on the wallpaper border includes an upper and/or lower repeating image pattern. The border image can be either a personalized image or a standard image. The latter is the preferred embodiment.

Next, the process proceeds to the select standard images steps. In this step the user selects the standard images referenced hereinabove. Preferably, these images come from a library of standard images that relate thematically to the user's previously determined preferences. The images can include licensed material such as sports logos, cartoon characters, nature scenes, and the like.

The next step in the process is the select personal images step wherein the user can select images that have meaning to them in reference to the chosen theme. Preferably, these images would be stored on the user's computer and could be uploaded by the software application.

After the images are selected, the user creates a wallpaper border segment design for review. While the arrangement of the objects can and will vary, the preferred arrangement would arrange the images on a wallpaper border that is six to eight inches in height, and between fifteen to thirty inches in length. The upper and lower border images would repeat over the upper and lower edge of the border, each image approximately one inch in height and an inch and one-half in width. The main standard image would appear spaced from one edge of the wallpaper border between the upper and lower border images, and then a personalized image would appear spaced apart from the standard image also between the upper and lower border images. Preferably, there would be a one and one-half inch gap between the edge of the wallpaper border and the standard image; the standard image would be four inches in height and six inches in width. A similar sized gap would appear between the standard image and the personalized image, wherein the personalized image is of the same or similar size as the standard image. A second standard and personalized image could be added in any pattern designated by the user. Once the image pattern is set, it would repeat to fill the wallpaper border segment width as necessary. Also, spacing and sizing adjustments could be made a necessary to space the images evenly across the wallpaper boarder segment.

After the wallpaper boarder is viewed, the user would either approve or reject the design. If the design were rejected, program control would allow for changes in design. If the design is approved, then program control passes to the select dimensions step.

In the select dimensions step, the previously created wallpaper border is used to create a roll. The roll consists of repeating sections of the wallpaper border and is preferably fifteen feet in length. If each wallpaper segment were 30 inches, then each segment would repeat six times in a roll. Other configurations are anticipated. For example, users could create more than one wallpaper segment, and a roll could consist of alternating segments. A user could incorporate from between one to six, thirty-inch wallpaper segments in a fifteen-foot roll. Additionally, the wallpaper segments can be more or less then thirty inches in length, or the roll could vary in length as well. Such changes create a large number of possible combinations. Of course, it is preferable that the length of the wallpaper segment be an even factor of the length of the roll to ensure that the wallpaper segments fit evenly on the roll.

The next step in the process is to create a high-resolution digital image file of the wallpaper border. In the preferred embodiment of the invention the file would be a high resolution Abode Acrobat (or .PDF) file. Other similar file types could be used as well.

Finally, the file is transferred electronically, or by other means, for printing in a conventional manner. The finished product would then by sent to the user, preferably by some type of postal delivery service.

The present invention is designed for compatibility with Print-On-Demand technology, which allows for printing a very small number of articles at a time, as low as one. Traditionally, printing was done in large batches. This involved substantial risk and cost, as the printer or printer's customers had to commit to a large run before knowing if they could sell the articles. Print-On-Demand allows for printing just one article on an as needed basis. As most of the wallpaper borders contemplated herein would be one-of-a-kind articles, Print-On-Demand technology is ideally suited for such a task.

The preferred embodiment of the present invention will now be disclosed in greater detail by reference to pseudo software application screenshots. Of course, those of ordinary skill in the art will understand that the exact configuration and design of the software application can and will vary without departing from the scope of the intended invention.

FIG. 2 shows in initial screen of the design application. In this screen the user would make a selection by either selecting an existing saved wallpaper border document, or creating a new wallpaper border document by choosing between a plurality of wallpaper border layout configurations. As stated hereinabove the layout configurations can vary. The wallpaper border segment can vary in length, the number of standard images, the number of custom images, and in other ways. For illustrative purposes, the layout configuration selected comprises two personalized images and a thirty-inch wallpaper border segment.

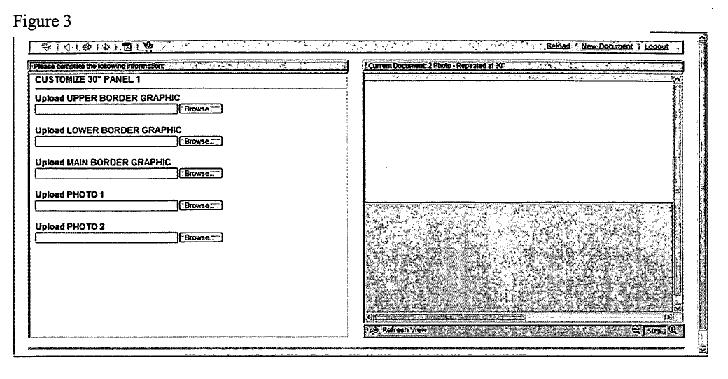

Next, the program displays the application screen shown in FIG. 3. In this step, the user can select the graphic images from drop down menus located in a left panel. A right panel displays the actual wallpaper border. After each selection is made, the user can select the Refresh View link at the bottom of the right panel to display the results of the most recent selections. The right panel also includes a magnification button to select the viewing area, and vertical and horizontal scroll bars to allow for viewing portions of the wallpaper border not shown in the viewing area.

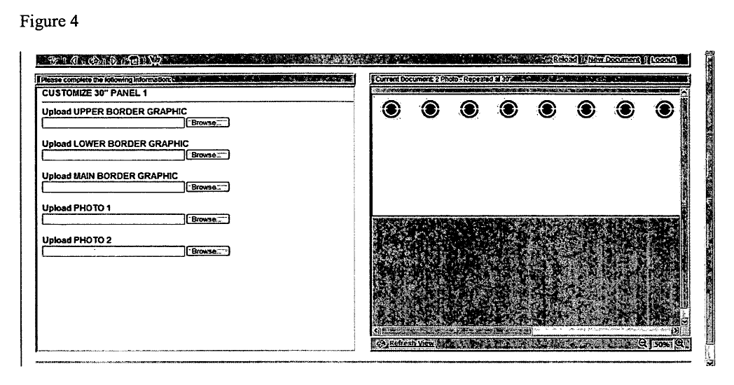

FIG. 4 shows the application screen after uploading an Upper Border Graphic, and selecting the Refresh View link. The graphic is selected by selecting the Browse button, which then allows the user to browse standard image directories stored at a central location, or browse directories on the user's computer if preferred by the user. The standard image directories are selected based on the theme determined earlier in the process. The upper border graphic is placed as an evenly spaced repeating pattern across the upper portion of the wallpaper border, as shown in the right panel. Additionally, in an alternative embodiment the user could select more than one Upper and/or Lower Border Graphic images from standard or custom images. The Graphics would then repeat. For example if two Upper Border Graphic images were selected they would repeat in a pattern of Graphic 1-Graphic 2, and so on.

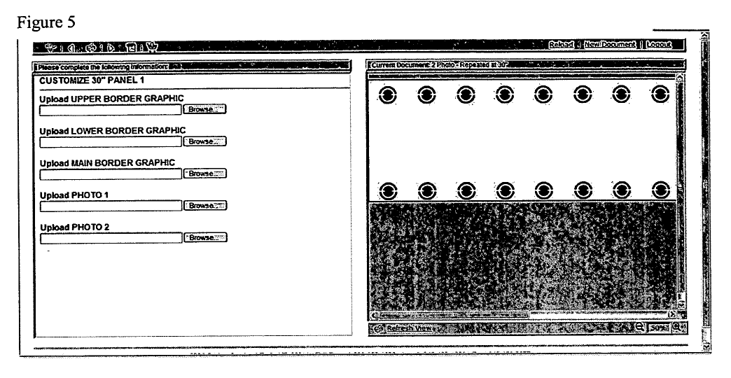

FIG. 5 shows the application screen after uploading a Lower Border Graphic, and selecting the Refresh View link. This step is essentially the same as the step disclosed in reference to FIG. 4, except that the graphic is displayed as the lower border. Also, the Lower Border Graphic can default to the Upper Border Graphic in case the user would like to use the same image as both an Upper and Lower Border Graphic.

Additionally, in an alternative embodiment the user could select more than one Upper and/or Lower Border Graphics from standard or custom images. The Graphics would then repeat as described hereinabove.

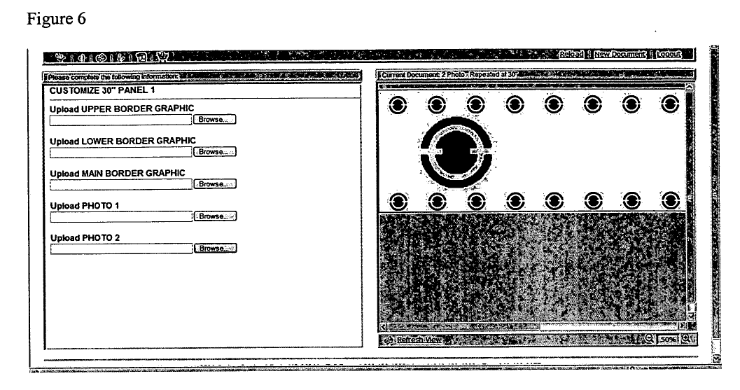

FIG. 6 shows the application screen after uploading a Main Border Graphic, and selecting the Refresh View link. The Main Border Graphic is preferably a standard graphic image. The standard graphics are preferably uploaded from the standard graphics directories provided from a central storage location, and are related to the user selected them. However, the user can select a personal or custom image as well. The Main Border Graphic image is displayed between the Upper and Lower Border Graphic images, and is placed first near the edge of the wallpaper border and then repeats in the manner described hereinbelow. Alternatively, the application could allow for selection of more than one Main Border Graphic images, wherein the multiple images would form a repeating pattern across the wallpaper border segment.

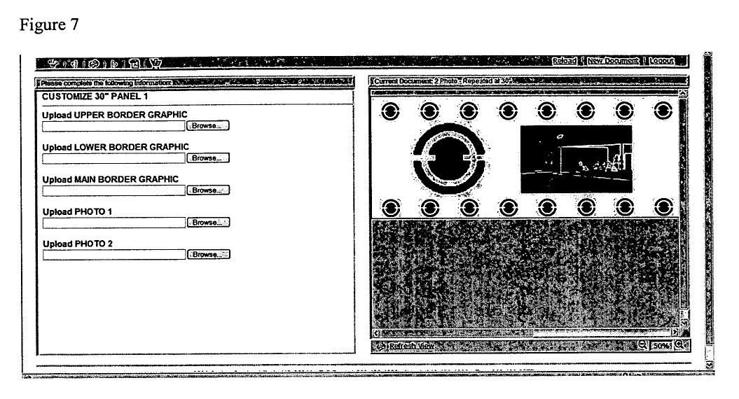

FIG. 7 shows the application screen after uploading a Photo 1, and selecting the Refresh View link. Photo 1 is preferably a personal or custom graphic image selected by the user. The image is preferably uploaded from the user's computer; however, a standard image can be selected if desired. Photo 1 is displayed between the Upper and Lower Border Graphic images and is placed in spaced apart relation to the Main Border Graphic in a patter that repeats across the wallpaper border.

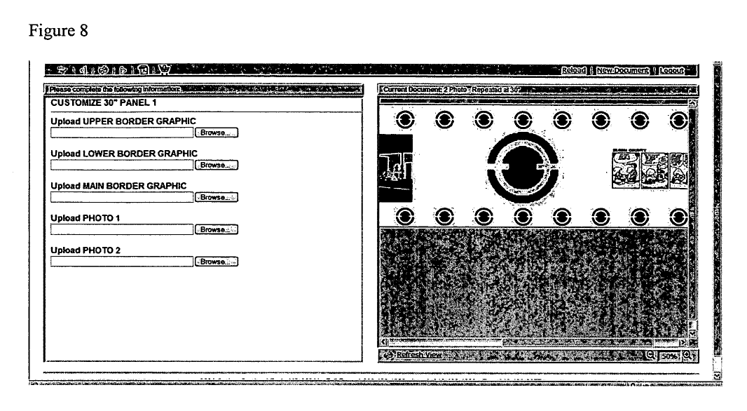

FIG. 8 shows the application screen after uploading a Photo 2, and selecting the Refresh View link. Photo 2 is preferably a personal or custom graphic image selected by the user. The image is preferably uploaded from the user's computer; however, a standard image can be selected if desired. Photo 2 is displayed between the Upper and Lower Border Graphic images and is placed in spaced apart relation to the Main Border Graphic in a patter that repeats across the wallpaper border. In particular, preferably the pattern as viewed from left to right comprises Main Border Graphic-Photo 1-Main Border Graphic-Photo 2, and repeats thereafter to fill the wallpaper border segment.

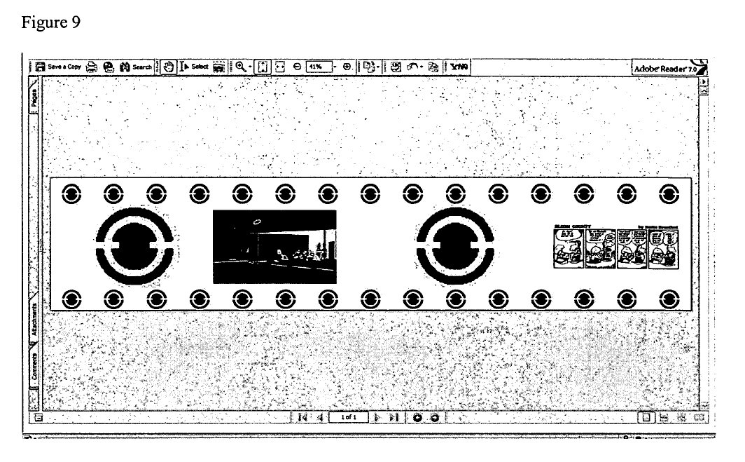

FIG. 9 shows the application screen after selecting the Adobe Acrobat icon located above the left panel graphic selection fields. This creates and displays in a separate window a high-resolution digital image of the wallpaper border segment to allow the user to review the design and make a determination whether to accept the design, or return to the application to select different images. If the user desires to change the wallpaper border segment, the user would merely repeat some or all of the forgoing image selection steps, until satisfied with the arrangement of images. Once the user has created an acceptable wallpaper border design, the user proceeds to the Checkout screen.

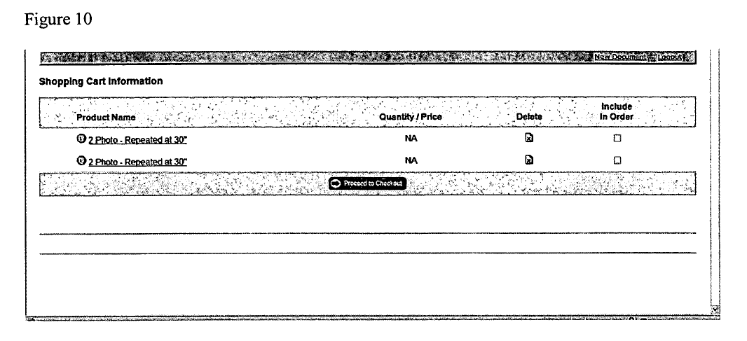

FIG. 10 shows the application screen after the user selects the Checkout option by selecting the shopping cart icon located above the left panel. The screen displays the Product Name of the wallpaper border(s) created by the user, a price, a checkbox to delete any item(s) that the user does not want to purchase, and a checkbox for selection of any item(s) the user desires to purchase. The user then would select the Proceed to Checkout icon, which would then proceed through a conventional series of payment screens.

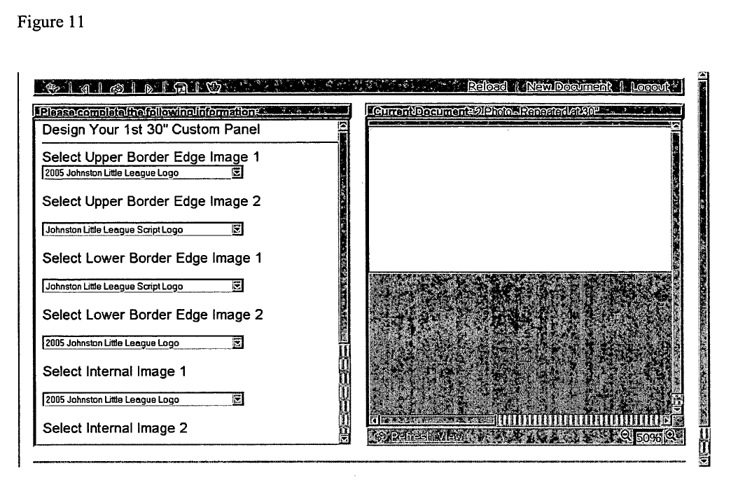

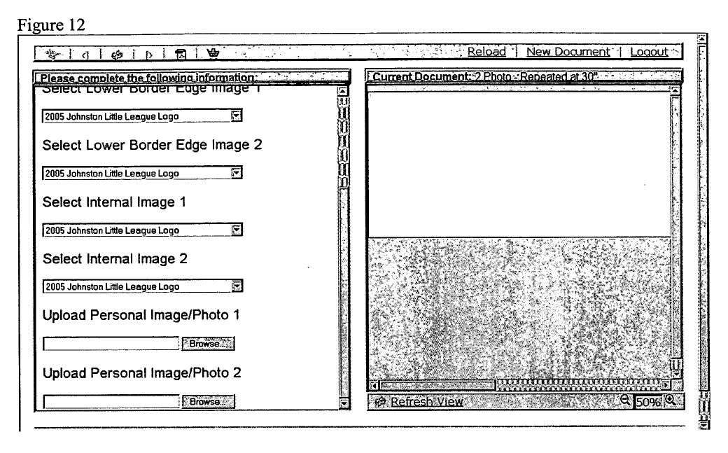

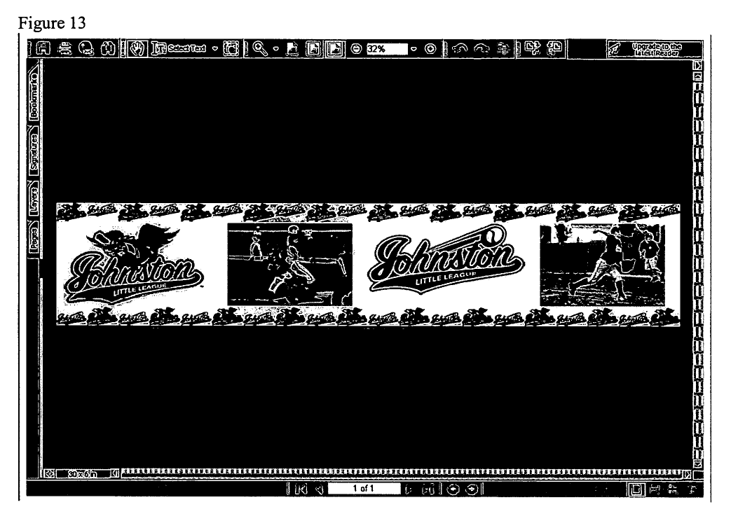

FIG. 11 shows an application screen of an alternative embodiment of the invention. This embodiment is similar in function as described above, however, includes different options for assembling images. This configuration allows the user to select two upper border graphic images, two lower border graphic images, two internal images, and two personal images (see FIG. 12). The border graphic images can be selected from standardized directories of images, or from personalized images stored on the user's computer. The same is true of the internal images. The personal images, however, would be provided by the user and preferably uploaded from the user's computer.

FIG. 13 shows a preview screen of a wall paper border constructed using the image arrangement depicted in FIGS. 11 and 12. The wallpaper border consists of two alternating upper border graphic images, and two alternating lower border graphic images. The center portion consists of an arrangement of the two internal images and the two personal images. These images repeat in a pattern of Internal Image 1-Personal Image 1-Internal Image 2-Personal Image 2. Of course, other arrangements are possible.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention. For example, different sizes and combinations of images can be used to create the wallpaper border segments, and the length of the wallpaper border segments would vary in proportion thereto. For example, a thirty inch wallpaper border segment would include two personal images and repeat six times in a fifteen foot roll, a sixty inch wallpaper border segment could include four personal images and repeat three times in a fifteen foot roll, a ninety inch wallpaper border segment could include six personal images and repeat two times in a fifteen foot roll, or a wallpaper panel could include twelve personal images with no repeats on a fifteen foot roll.

Furthermore, as the present invention is easily adapted for creating personalized wallpaper borders for children's bedrooms, it is contemplated that as the child grows the child's interests will change. Thus, it is anticipated that new wallpaper borders would be created and replaced with some frequency, and for this reason releasable adhesive could be used on the wallpaper border to facilitate removal.

1. A method for creating a personal wallpaper border, comprising:
providing a computer software application for performing the steps of the method;
launching said software application;
selecting at least one standard image;
selecting at least one personal image;
arranging said images in a predetermined pattern to create a wallpaper border segment; and
creating a computer readable output file comprised of said arranged images adapted to be printed as a wallpaper border.

2. The method of claim 1 wherein said arrangement of images further comprises placing one of said images in an upper or lower border graphic area.

3. The method of claim 3 wherein said arrangement of images further comprises placing one of said image in a main graphic area located between said border graphic areas.

4. The method of claim 4 further comprising a query step to determine a theme wherein said standard images are selected from a group of images related to said theme.

5. The method of claim 1 further comprising the step of selecting an upper and a lower border graphic image, and wherein said upper and lower graphic images are placed respectively in repeating order across an upper and a lower border graphic areas, and wherein said standard and said personal images are placed in alternating repeating order between said border graphic areas.
